(19) United States
(12) Patent Application Publication
(10) Pub. No.: US 2003/0128231 A1
(43) Pub. Date: Jul. 10, 2003

(54) Dynamic path analysis

(76) Inventors: Stephane Kasriel, San Francisco, CA (US); Sara Swanson, Los Gatos, CA (US)

Correspondence Address: ROBERT M. MCDERMOTT, ESQ., 1824 FEDERAL FARM ROAD, MONTROSS, VA, 22520, US

(21) Appl. No.: 10/128,597

(22) Filed: Apr. 22, 2002

Related U.S. Application Data
(60) Provisional application No. 60/347,389, filed on Jan. 9, 2002.

(51) Int. Cl. G09G 5/00

(52) U.S. Cl. 345/736

(57) ABSTRACT

A user interface allows a user to select parameters used for filtering path-analysis data, to target specific traversals, and a display processor presents the path-analysis based upon this user-defined filtering. Preferably, the presentation of the path-analysis is in graphic form. A directed graph is presented that illustrates path information as annotated links between nodes of the graph. Each node in this presentation represents a web-address and each link represents traversals between two of the nodes. The traversals include traversals among the nodes satisfying the filter constraints. Presenting the filtered path-analysis information in a graphical form provides the user with a more immediate and intuitive understanding of the flow of targeted visits to and through a user's web-site. The filtering can be effected as either a pre-process that affects the collection of path-analysis data, or as a post-process that affects the reporting of the path-analysis data, or as a combination of pre-processing and post-processing.

This application claims the benefit of U.S. Provisional Application No. 60/347,389, filed Jan. 9, 2002, Attorney Docket FC011022B.

### BACKGROUND OF THE INVENTION

1. Field of the Invention

This invention relates to the field of computer networks, and in particular to a system and method that facilitates an analysis of traffic patterns within and between sites on a network.

2. Description of Related Art

Traffic analysis is a necessary tool for effective web-site management and on-going web-site development, as well as for the development of effective marketing strategies. Web-site managers, hereinafter webmasters, desire information that can be used to enhance the web-site's performance or appearance. Electronic-commerce marketing managers, hereinafter marketers, desire information that can be used to enhance the sales resulting from visits to a web-site, to enhance advertising revenue from the web-site, and/or to determine the effectiveness of advertising expenses to other web-site providers.

Tools are commonly available for collecting traffic data. A fundamental tool, for example, collects data regarding the number of times each page at a web site is accessed within a given period of time (e.g. ‘hit-rate’ statistics). A more sophisticated tool, such as the Netflame™ product from Fireclick, Inc., collects data regarding entries to and exits from each page at a web site. By tracking visitors' paths through the website, a Netflame™-enabled web-site can be configured to anticipate a next-page that a visitor is likely to visit, and can initiate a download of some or all of the anticipated next-page while the visitor is viewing the current page. In this manner, the performance of the web-site is significantly enhanced, because, from the visitor's perspective, the anticipated next-page appears to download instantaneously. Only if the visitor chooses an unanticipated next-page will the visitor experience the true download delay duration.

Copending U.S. patent application “PREDICTIVE PRE-DOWNLOAD USING NORMALIZED NETWORK OBJECT IDENTIFIERS”, Ser. No. 09/734,910, filed Dec. 11, 2000 for Stephane Kasriel, Xavier Casanova, and Walter Mann, discloses a preferred technique for determining and downloading the anticipated next-page, and is incorporated by reference herein. Of particular note, this copending application also discloses the concept of a “normalized” web-page, wherein alternative versions of a web-page are analyzed and processed as a single web-page. That is, alternative versions of a web-page may include an element that varies, depending upon the environment, the particular viewer, the class of viewer, a currently advertised special, and so on. Each version may potentially correspond to a different web-page, because each version may have a different URL (Uniform Resource Locator). If processed and analyzed separately, the individual statistics that are associated with each of the different versions of a web-page would generally be meaningless. A normalized web-page comprises all of the non-varying elements of the alternative versions, and the data collected corresponding to each of the alternative versions is associated with the normalized web-page. In this manner, statistics are provided for the web-page, independent of variables associated with the web-page. For ease of reference and understanding, the term web-page as used herein includes a normalized web-page, and other collections of pages, files, and data that form a cohesive entity for traffic-analysis reporting purposes. For example, copending U.S. patent application “PREDICTIVE PREDOWNLOAD OF TEMPLATES WITH DELTA ENCODING, Ser. No. 10/079,932, filed Feb. 19, 2002 for Stephane Kasriel, incorporated by reference herein, discloses the use of “templates” that correspond to the relatively unchanging portions of a web-page, and “delta-encoding” to encode the portions of a web-page that change. As defined herein, the templates with multiple and varied delta-encodings correspond to a web-page. Other examples of collections of material forming a cohesive entity for traffic-analysis will be evident to one of ordinary skill in the art.

A marketable traffic-analysis product must include one or more tools for providing reports that are based on the collected traffic-pattern data. Generally, traffic analysis tools provide pre-defined reports, or allow a user to create custom reports, or both. The typical reporting tools are conventional data-processing tools that provide tables of statistics, graphs of trends over time, and so on. Generally, the reports that are produced are ‘static’ reports that provide snap-shots of traffic patterns related to a particular web-site. As such, the use of such reports for determining the effectiveness of changes to a web-site, or the effectiveness of targeted marketed campaigns, is cumbersome, at best.

### BRIEF SUMMARY OF THE INVENTION

It is an object of this invention to present customizable traffic-analysis and/or path-analysis data. It is a further object of this invention to allow a user to modify the content of the traffic-analysis and path-analysis data.

These objects, and others, are achieved by providing a method and system for dynamically filtering path-analysis data. A user interface allows a user to select parameters used for filtering the path-analysis data, to target specific traversals, and a display processor presents the path-analysis based upon this user-defined filtering. Preferably, the presentation of the path-analysis is in graphic form. A directed graph is presented that illustrates path information as annotated links between nodes of the graph. Each node in this presentation represents a web-address and each link represents traversals between two of the nodes. The traversals include traversals among the nodes satisfying the filter constraints. Presenting the filtered path-analysis information in a graphical form provides the user with a more immediate and intuitive understanding of the flow of targeted visits to and through a user's web-site. The filtering can be effected as either a pre-process that affects the collection of path-analysis data, or as a post-process that affects the reporting of the path-analysis data, or as a combination of pre-processing and post-processing.

### BRIEF DESCRIPTION OF THE DRAWINGS

The invention is explained in further detail, and by way of example, with reference to the accompanying drawings wherein:

FIG. 1 illustrates an example block diagram of a path analysis system in an Internet environment in accordance with this invention.

FIG. 2 illustrates an example graphic display of path analysis information in accordance with this invention.

FIGS. 3A-3B illustrates example block diagrams of alternative dynamic path-analysis systems in accordance with this invention.

Throughout the drawings, the same reference numerals indicate similar or corresponding features or functions.

### DETAILED DESCRIPTION OF THE INVENTION

This invention is presented herein using the paradigm of a path-analysis system having the capabilities of the aforementioned Netflame™ product from Fireclick, Inc. As will be evident to one of ordinary skill in the art, the principles of this invention are applicable to other traffic-analysis and path-analysis systems and products.

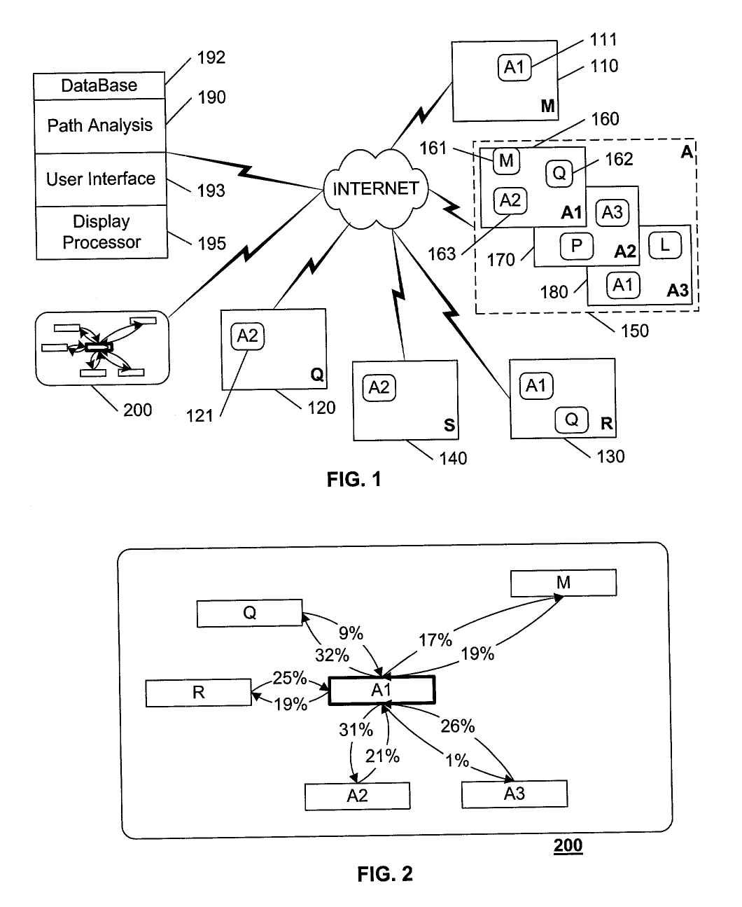

FIG. 1 illustrates an example block diagram of a web-page path analysis system in an Internet environment in accordance with this invention. A number of web-sites M 110, Q 120, R 130, S 140, and A 150 are illustrated as being a part of the Internet network. Web-site A 150 is illustrated as containing three web-pages 160, 170, 180, whereas, for ease of understanding web-sites M 110, Q 120, R 130, and S 140 are illustrated as single web-pages.

Each of the web-pages 110-180 is illustrated as containing one or more “buttons” for traversing to another web-page. Web-page M 110, for example, contains a button 111 that effects a traversal to web-page A1 160. Web-page Q 120 contains a button 121 that effects a traversal to web-page A2 170. Web-page A1 160 contains buttons 161, 162, 163 that effect a traversal to web-pages M 110, Q 120, and A2 170, respectively. Not illustrated, conventional web-browsers include “back” and “forward” buttons for traversing to prior accessed web-pages.

Also illustrated in FIG. 1 is a path-analysis block 190 that is configured to detect and record traversals to and from select web-sites, and to record performance-related data associated with each visit to the select web-sites. In the aforementioned Netflame™ product, a subscriber to the path-analysis program adds a line of program code to each web-page. This line of program code effects a recording of parameters associated with each visit to the web-page, as discussed further below. Any of a variety of techniques, common in the art, can be employed to record and collect this information. Generally, one or more processes are used to record the information in a database 192, and another process is used to retrieve the information. For the purposes of this disclosure, a database is any collection of data that facilitates efficient retrieval of the data, and may include a distribution of data storage entities. In this example, the path-analysis block 190 accesses the database 192 to record data and retrieve statistics related to visits to each web-page A1-A3 160-180 of the subscribing web-site A 150.

Copending U.S. patent application “INTERACTIVE PATH ANALYSIS”, Ser. No. ______, filed concurrently for Stephane Kasriel and Sara Swanson, Attorney Docket FC020115, teaches a user interface 193 and display processor 195 that is configured to display the rate of traversals among web-pages, preferably as a directed graph 200, and is incorporated by reference herein.

FIG. 2 illustrates an example graphic display 200 of traversal information in accordance with this copending application. In this example, the web-pages and the traversals between the web-pages are illustrated as nodes and links, respectively, in a directed graph. In the example display 200, web-page A1 has been identified as the target, and all of the traversals to and from web-page A1 are illustrated. The percentages associated with each link represent the percentage of traversals to and from A1, relative to node A1. For example, the link from node R to A1 indicates 25%. This figure indicates that 25% of the traversals to A1 arrive from node R. In like manner, 9% of the traversals to A1 are from Q, 19% from M, 21% from A2, and 26% from A3, thereby accounting for 100% of the traversals to A1. Regarding traversals from node A1, 19% are to R, 32% to Q, 17% to M, 31% to A2, and 1% to node A3.

This graphic presentation presents useful information to a marketer or a Webmaster. Note, for example, that although 25% of the traversals to node A1 are from node R, 19% of the traversals are back to node R. As illustrated in FIG. 1, the example web-page A1 160 does not have a button for linking to node R. Therefore, the 19% of the traversals from A1 to R must have been in response to a visitor hitting the “back” button on the visitor's browser. Typically, a user hits the back button when the visitor discovers that the content of the selected page was not what the visitor was looking for, or when the visitor loses patience with an excessive download delay or other web-page anomaly. From a marketing viewpoint, the presentation of A1 at web-page R is apparently very effective for bringing visitors to A1 from R, but most of these visitors are apparently disappointed when they arrive at A1, and return to R. Other insights can be gained from this presentation, as will be evident to one of skill in the art of e-commerce.

Copending U.S. patent application “WEB-SITE ANALYSIS SYSTEM”, Ser. No. ______, filed concurrently for Stephane Kasriel, Sara Swanson, and Walter Mann, Attorney Docket FC020116, teaches the use of a database for collecting performance information related to accesses to web-pages, in addition to the conventional path-analysis information, and is incorporated by reference herein. In this copending application, the database (192 in FIG. 1) includes time duration measures associated with each visit to each web-page, for reporting average web-page download times, average visit duration to each web-page, and so on. Additionally, the collected data includes such items as the web-page at which each web-site access commenced, the web-page from which the web-site access terminated, the frequency of use of the back button at each web-page, and so on. The use of this data in the context of a conventional path analysis allows for potential web-pages problems to be identified, and the effectiveness of marketing or web-page development programs to be evaluated.

In accordance with this invention, the database 192 is structured to include ancillary information related to each web-site access. Of particular note, the ancillary information includes the date and time of each access, and detailed information related to each visitor. This detailed information includes the visitor's geographic location, whether the visitor is a new or returning visitor, whether the user has purchased products from the web-site, the cumulative purchase amount, the user's preferences, and so on. Generally, this ancillary information is obtained from one or more third-party databases, based on the visitor's IP address or other identifier. For example, some visitors voluntarily provide personal information to a third-party database, and identify themselves as members of this database collection via a “cookie” that is attached to the visitor's request for access to a web-page.

By collecting this ancillary information with each access, the path-analysis and performance-analysis reports can be filtered based on this ancillary information. For example, a marketing campaign may be directed to a particular geographic region of the country. To assess the effectiveness of the campaign, the data can be filtered and displayed to show the path-analysis information for all accesses from that geographic region within the dates that the campaign was conducted. Additionally, all accesses from that geographic region before and after the dates of the campaign can be displayed, for comparison purposes.

In like manner, the path-analysis information may be contrasted between new-visitors and returning-visitors, or between buying-visitors and non-buying-visitors, to determine whether different marketing strategies are warranted for each group, and then to determine the effectiveness of these strategies.

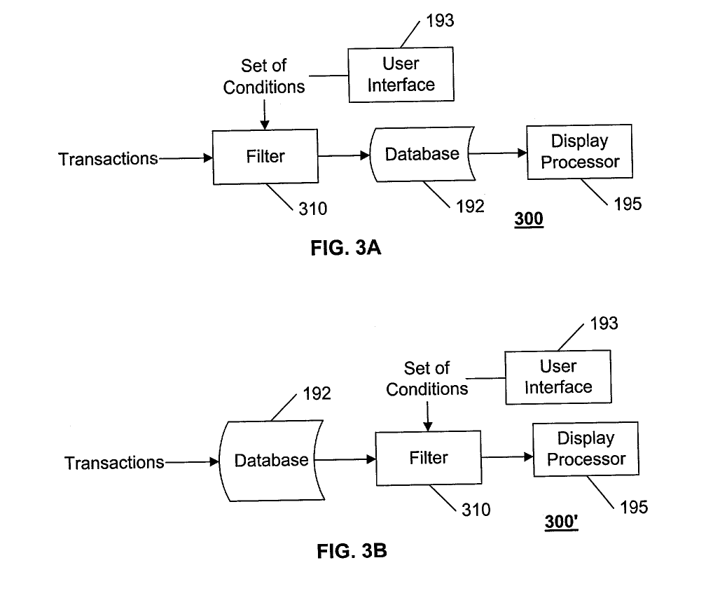

FIGS. 3A and 3B illustrate example block diagrams of two alternative embodiments 300 and 300′ of a dynamic path analysis system in accordance with this invention. In FIG. 3A, a filter 310 filters transactions before the transactions are stored in the database 192. For ease of reference, the term ‘transaction’ is used herein to include any interaction between a visitor and a web-site. In the context of this invention, the transactions of primary interest are visits to web-pages within the web-site, including an identification of traversals to and from each web-page. However, other interactions between a visitor and the web-page, such as whether the user filled out a form on the web-page, and so on, may also be transactions of interest.

In accordance with this invention, a user interface 193 is provided to allow a user to define a set of conditions for application by the filter 310. In the embodiment of FIG. 3A, because the filter 310 filters the transactions before the transactions are stored in the database 192, the amount of data stored in the database 192 can be substantially reduced, because only transactions that satisfy the given set of conditions will be stored in the database 192.

Optionally, the techniques presented in the aforementioned copending application “WEB-SITE ANALYSIS SYSTEM” can be applied to further optimize the collection and retrieval of performance data related to pages on a web-site. This copending application teaches the use of a two-stage storage process. Data is collected in a register set that is structured for efficient access, and periodically uploaded to a database for long-term storage and further analysis. The register set accumulates the data between each upload, and the data in the database constitutes periodic samples of the performance data. A1so taught in the copending application, a plurality of register sets are provided, and the data is periodically shifted through these register sets, thereby providing a moving window representing periodic samples of the most recent performance of the web-site. Typically, the data is shifted into the database and through twenty-four register sets each hour, thereby providing a day's worth of hourly performance data in the register sets. Because the data is available in register sets that are optimized for efficient access, the analysis and reporting of recent performance can be efficiently performed via access to these register sets. Reports based on older data, on the other hand, require access to a relatively large database, and the performance and complexity of a typical database access program does not necessarily support interactive analysis.

Typically, one of the conditions for filtering the transactions is a selected time-frame for the analysis. This time-frame is usually related to a particular marketing campaign for evaluating the effectiveness of the campaign, or a test and evaluation period for evaluating the performance of a web-site after changes are made. Applying the two-stage storage process of the aforementioned copending application to this invention, the number of register sets allocated to a time-limited evaluation task can be allocated to correspond to the specified time-frame condition. In this manner, all of the analyses and reports can be generated from the data in the register sets, thereby facilitating efficient interactive analysis. Optionally, because all of the parametric data is available for analysis and reporting directly from the register sets, the data need not be uploaded to the database until after the completion of the specified time-frame, thereby minimizing the number of uploads.

Often, one of the filter conditions includes a selection of web-pages of interest during the evaluation period. For example, a particular marketing campaign, or a particular test, may be expected to significantly affect only a few web-pages of a web-site. As also taught in the copending application, most of the data in the register sets is organized per web-page. Therefore, to further optimize storage requirements, a preferred embodiment of this invention allocates the register sets to correspond to the specified web-pages of interest, and does not allocate register sets to web-pages that were not specified as being of interest during the evaluation period.

In like manner, the filter conditions may include the selection of particular parameters of interest, and the register sets for collecting the data can be sized to collect only the selected parameters.

In a preferred embodiment of this invention, the user specifies a ‘target’ location of interest. This target may include all of the pages of the web-site, or a select set of pages of interest within the web-site. For ease of reference, the term ‘target’ is used hereinafter in the singular, even though the target may include multiple web-pages. The particular traversal to or from the target location may also be specified, to include, for example, transactions wherein the target location is the entry location of an access to the web-site, or transactions wherein the target location was visited at some time during the access to the web-site, or transactions wherein the target location was the exit location of an access to the web-site. Other conditions may be specified regarding the traversals, including a filtering based on the incoming link, from which the access to the web-site originated. For example, the user may specify that only traversals from “.edu” sites are of interest, or only traversals from one or more “yahoo” sites, and so on. In like manner, the filtering may be based on outgoing links, to which the visitor traversed upon exiting the web-site.

Preferably, when the transaction related to the target location satisfies the filter conditions, all of the transactions of that particular access to the web-site are stored in the database 192. In a preferred embodiment, the transactions of each access are stored temporarily, and the filtering process is applied when the access terminates. If the conditions specified for the target location are satisfied during this access, the transactions of the access are stored, otherwise, they are discarded. In this manner, the path analysis and performance analysis reports can be provided for all accesses that satisfy the given conditions relative to the target location.

The conditions may be applied in a variety of forms. For example, the user may request “all accesses to the web-site from ‘yahoo.com’ that include at least one visit to ‘pages A, B, or C’”, or, “all accesses to the web-site from ‘yahoo.com’ wherein the visitor entered the web-site via ‘pages A, B, or C’”, or, “all accesses to the web-site from ‘yahoo.com’ wherein the visitor entered the web-site via ‘page A’, and visited ‘page B or C’. Such conditions can be particularly effective for determining the effectiveness of an advertising campaign, such as the placement of a ‘banner ad’ at a select site (‘yahoo.com’), that traverses to a particular page on the web-site. As is evident to one of ordinary skill in the art in view of this disclosure, a variety of methods of accessing and filtering data in a data base may be used to embody this invention, and include, for example, free-form query languages, knowledge-based expert systems, Boolean queries, and the like.

In addition to conditions directly related to the traversals of web-pages, the user is provided the option of applying other filter conditions. The user, for example, may include a range of dates and/or times of access as a filter condition. The user may also include a classification of the visitor as a filter condition. In a preferred embodiment, an identification of the visitor is included in the transaction information associated with an access to the web-site. From this identification, another database may be accessed that contains a history of transactions associated with the visitor, if any. The user may include a condition to include only visitors that have visited the web-site previously, or only visitors that have purchased items from the web-site, or only visitors that have visited frequently, and so on. The visitor identification may also provide an indication of the geographic location of the visitor, from which the user can select only visitors from a given geographic location or region. The visitor identification may include an Internet address associated with the visitor, such as an “@aol.com” e-mail address, identifying the visitor as an AOL subscriber. The use of other visitor-related information for targeted path or performance analysis, such as gender, age, preferences, and so on, if available, will be evident to one of ordinary skill in the art in view of this disclosure.

After the transactions related to an access that satisfies the set of user conditions are stored in the database 192, a display processor 195 presents the path-analysis or performance-analysis information to the user, based on this stored data. In a preferred embodiment of this invention, as in the referenced copending U.S. patent applications, the path-analysis information is preferably presented as a directed graph that is customizable by the user to include, for example, user-defined aliases for each web-page or group of web-pages, the use of color or graphics to convey information of interest, and so on. Note that, because only transactions that satisfy the user's set of conditions are stored in the database 192 in this embodiment, the display processing 195 can generally be performed quickly, thereby allowing for a highly interactive web-analysis process.

In FIG. 3B, an alternative embodiment 300′ is illustrated wherein the filter 310 is applied after the transactions are stored in the database 192. In this embodiment 300′, all transactions are recorded in the database 192. Although this generally requires the storage of substantially more information than the embodiment 300 of FIG. 3A, it allows the user substantial flexibility in creating path-analysis and performance-analysis reports. In the embodiment 300 of FIG. 3A, a user must predefine the conditions that identify future transactions of interest. Transactions that do not satisfy the conditions are discarded, and not available for subsequent analysis.

In the embodiment 300′, the user specifies a set of conditions via a user interface 193, as in the embodiment 300, discussed above. Because the database 192 contains all transactions related to the web-site, the user can define any set of past conditions, without regard to predefined transactions of interest. The filter 310 applies the conditions to the data in the database 192, and the display processor 195 processes the filtered information to present path-analysis and performance-analysis reports to the user, as discussed above with regard to FIG. 3A.

The foregoing merely illustrates the principles of the invention. It will thus be appreciated that those skilled in the art will be able to devise various arrangements which, although not explicitly described or shown herein, embody the principles of the invention and are thus within its spirit and scope. For example, a hybrid combination of the embodiments of FIGS. 3A and 3B may also be embodied, wherein a first set of conditions is applied to pre-filter the information before storing the data in the database, and a second set of conditions is applied to post-filter the information for presentation by the display processor. In such an embodiment, for example, the pre-filtering may be “all accesses that include a visit to ‘page X’”, and the post-filtering may limit the information to particular dates of interest, or the source of the entry traversal, or the connection speed, and so on. These and other system configuration and optimization features will be evident to one of ordinary skill in the art in view of this disclosure, and are included within the scope of the following claims.

We claim:

1. A system comprising:
a user interface that is configured to allow a user to identify a set of conditions associated with accesses to a web-site, and
a display processing device, operably coupled to the user interface, that is configured to display parameters associated with accesses to the target location that satisfy the set of conditions.

2. The system of claim 1, further including
a database, operably coupled to the display processing device, that is configured to collect data associated with the accesses to the web-site that satisfy the set of conditions, and
wherein
the display processing device is configured to display the parameters based on the data in the database.

3. The system of claim 1, further including
a database, operably coupled to the display processing device, that is configured to collect data associated with the accesses to a web-site, and
wherein
the display processing device is configured to determine the parameters based on select data in the database that satisfy the set of conditions.

4. The system of claim 1, wherein
accesses to the web-site include visits to a plurality of web-pages of the web-site,
the user interface is further configured to allow the user to select a target from among the plurality of web-pages, and to identify one or more conditions of the set of conditions relative to the target.

5. The system of claim 4, wherein
the one or more conditions include at least one of:
a time of access to the target,
a date of access to the target,
a duration of access to the target,
a mode of access to the target,
an incoming link to the target, and
an outgoing link from the target.

6. The system of claim 1, wherein
the one or more conditions include at least one of:
a time of access to the web-site,
a date of access to the web-site,
a duration of access to the web-site,
a mode of access to the web-site,
an incoming link to the web-site, and
an outgoing link from the web-site.

7. The system of claim 1, wherein
the one or more conditions include conditions related to an identification of each visitor accessing the web-site.

8. The system of claim 7, wherein
the conditions related to the identification of each visitor include at least one of:
a geographic location of the visitor,
an Internet address of the visitor,
one or more prior accesses to the web-site by the visitor, and
one or more prior purchases from the web-site by the visitor.

9. The system of claim 7, wherein
the conditions related to the identification of each visitor include at least one of:
a gender of the visitor,
an age of the visitor, and
one or more preferences of the visitor.

10. A method of providing path-analysis information, comprising:
filtering transactions related to a web-site, based on a set of user-defined conditions, to provide filtered transactions, and
displaying path-analysis information regarding traversals among web-pages of the website, based on the filtered transactions.

11. The method of claim 10, further including:
storing the transactions in a database for subsequent filtering.

12. The method of claim 10, further including:
storing the filtered transactions in a database for subsequent display processing for displaying the path analysis information.

13. The method of claim 10, wherein
the user-defined conditions include at least one of:
a time of access to the web-site,
a date of access to the web-site,
a duration of access to the web-site,
a mode of access to the web-site,
an incoming link to the web-site, and
an outgoing link from the web-site.

14. The method of claim 10, wherein
the user-defined conditions include conditions related to an identification of each visitor accessing the web-site.

15. The method of claim 14, wherein
the conditions related to the identification of each visitor include at least one of:
a geographic location of the visitor,
an Internet address of the visitor,
one or more prior accesses to the web-site by the visitor, and
one or more prior purchases from the web-site by the visitor.

16. The method of claim 14, wherein
the conditions related to the identification of each visitor include at least one of:
a gender of the visitor,
an age of the visitor, and
one or more preferences of the visitor.

17. The method of claim 10, wherein
the path-analysis information includes a directed graph that illustrates traversals among the web-pages of the web-site.

18. A method of providing a web-site analysis, comprising:
collecting data related to accesses to a web-site,
filtering the data based on user-defined conditions to provide filtered data, and
providing path-analysis information based on the filtered data.

19. The method of claim 18, wherein
providing path-analysis information includes
displaying a directed graph that illustrates traversals among web-pages of the web-site.

20. The method of claim 18, further including at least one of:
storing the data in a database, and
storing the filtered data in the database.

21. The method of claim 18, wherein
the user-defined conditions include at least one of:
a time of access to the web-site,
a date of access to the web-site,
a duration of access to the web-site,
a mode of access to the web-site,
an incoming link to the web-site, and
an outgoing link from the web-site.

22. The method of claim 18, wherein
the user-defined conditions include conditions related to an identification of each visitor accessing the web-site.

23. The method of claim 22, wherein
the conditions related to the identification of each visitor include at least one of:
a geographic location of the visitor,
an Internet address of the visitor,
one or more prior accesses to the web-site by the visitor, and
one or more prior purchases from the web-site by the visitor.

24. The method of claim 22, wherein
the conditions related to the identification of each visitor include at least one of:
a gender of the visitor,
an age of the visitor, and
one or more preferences of the visitor.
